(19) United States
(12) Patent Application Publication
(10) Pub. No.: US 2025/0315097 A1
(43) Pub. Date: Oct. 9, 2025

(54) BATTERY RUNTIME OPTIMIZATION

(71) Applicant: DELL PRODUCTS L.P., Round Rock, TX (US)

(72) Inventors: Suraj M Varma, Portland, OR (US); Farzad Khosrowpour, Pflugerville, TX (US); Travis North, Cedar Park, TX (US)

(21) Appl. No.: 18/628,156

(22) Filed: Apr. 5, 2024

(51) Int. Cl. G06F 1/3287

(52) U.S. Cl. CPC G06F 1/3287

(57) ABSTRACT

An information handling system includes a battery, a central processing unit, and a processor. The central processing unit includes a plurality of processor cores. The processor monitors a relative state of charge of the battery. The processor transmits a first portable code to modify a user-selectable thermal table mode based on the relative state of charge of the battery. The processor transmits a second portable code to disable one of the processor cores of the central processing unit based on the relative state of charge of the battery.

### FIELD OF THE DISCLOSURE

The present disclosure generally relates to information handling systems, and more particularly relates to battery runtime optimization.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a battery, a central processing unit, and a processor. The central processing unit includes a plurality of processor cores. The processor may monitor a relative state of charge of the battery. The processor may transmit a first portable code to modify a user-selectable thermal table mode based on the relative state of charge of the battery. The processor may transmit a second portable code to disable one of the processor cores of the central processing unit based on the relative state of charge of the battery.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system, according to an embodiment of the present disclosure;

FIGS. 2-4 are block diagrams of an information handling system, according to an embodiment of the present disclosure;

FIG. 5 is a flowchart of a method for battery runtime optimization, according to an embodiment of the present disclosure;

FIG. 6 is a flowchart of a method for processor core restoration to default status, according to an embodiment of the present disclosure; and

FIG. 7 is a table of a mapping of a battery's relative state of charge to processor core counts and user-selectable thermal table modes, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

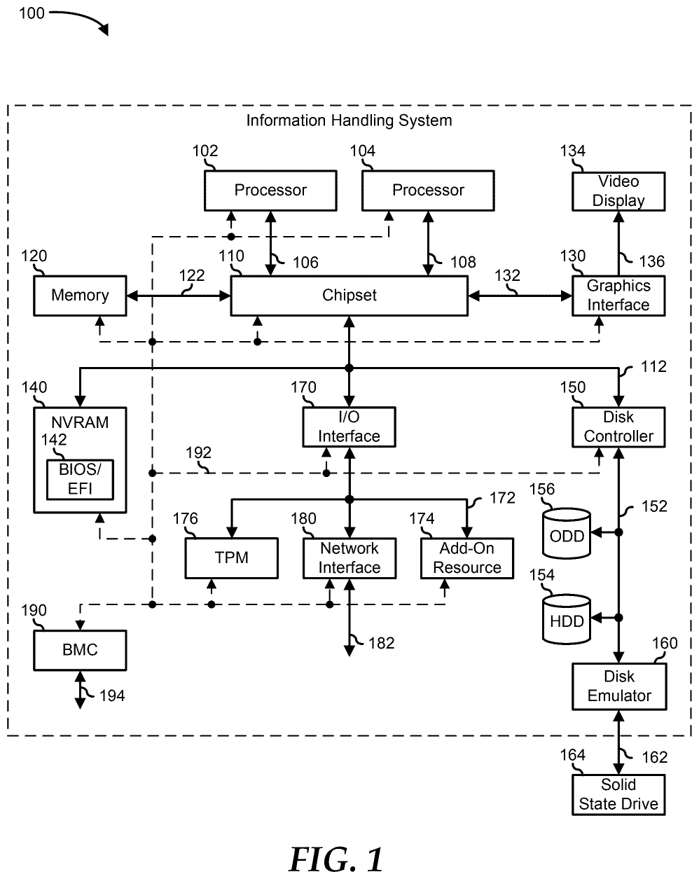

FIG. 1 illustrates an embodiment of an information handling system 100 including processors 102 and 104, a chipset 110, a memory 120, a graphics adapter 130 connected to a video display 134, a non-volatile RAM (NVRAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NVRAM 140, disk controller 150, and I/O interface 170 are connected to chipset 110 via an I/O channel 112. An example of I/O channel 112 includes one or more point-to-point PCIe links between chipset 110 and each of NVRAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I2C) interface, a System Packet Interface, a Universal Serial Bus (USB), another interface, or a combination thereof. NVRAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller. A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Information can be sent from the management system to BMC 190 and the information can be stored in a RAM or NVRAM associated with the BMC. Information stored in the RAM may be lost after power-down of the power plane for BMC 190, while information stored in the NVRAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Portable information handling systems typically have internal batteries to power the system without a need for an external power source, such as an alternating current (AC) power outlet. An internal battery provides users with greater flexibility by allowing free movement even while the system is running. One concern in the design and use of portable information handling systems is the availability of sufficient battery life in the system to provide a reasonable operating time before the battery charge expires and a recharge is needed. Further, as processing components become more powerful over time, the power consumed by these components has tended to increase, which decreases battery life. Thus, there is a need to manage battery power to allow for longer battery life. Hybrid CPU platforms support performance and efficient processor cores to provide varying levels of performance and power usage. The present disclosure provides a system and method to leverage the ability of the hybrid CPU platform to dynamically change a processor core count available to an operating system to drive the battery life of the system. In addition, the present disclosure uses a capability of a user-selectable thermal table (USTT) to select system thermal and acoustic levels in optimizing battery life.

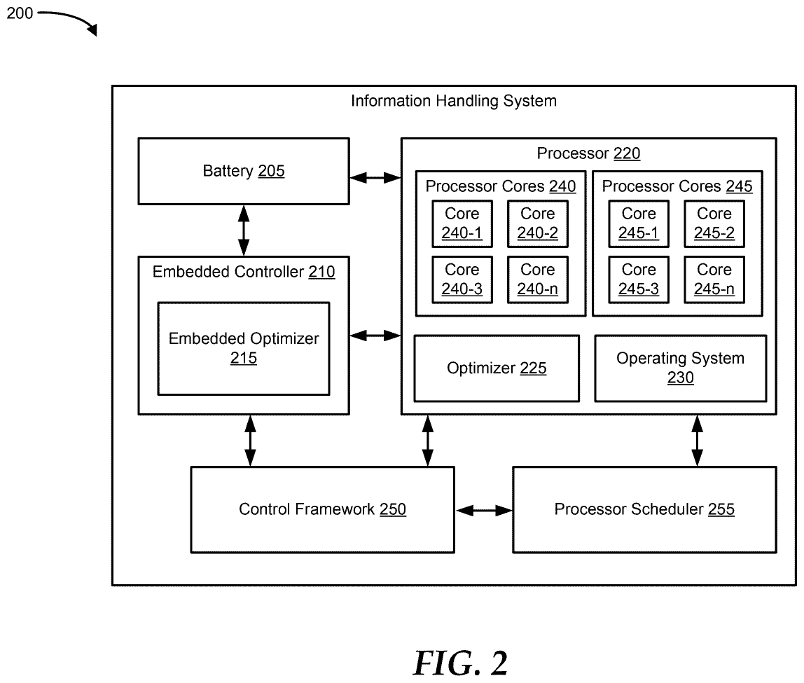

FIG. 2 shows a portion of an information handling system 200, according to at least one embodiment of the present disclosure. Information handling system 200, which is similar to information handling system 100 of FIG. 1, includes a battery 205, an embedded controller 210, a processor 220, a control framework 250, and a processor scheduler 255. Embedded controller 210 includes an embedded optimizer 215. Processor 220 includes an optimizer 225, operating system 230, processor cores 240, and processor cores 245. Processor cores 240 includes processor cores 240-1 through 240-n. Processor cores 245 include processor cores 245-1 through 245-n. Processor 220 may be coupled to battery 205, embedded controller 210, control framework 250, and processor scheduler 255. Processor 220, which is similar to processor 102 or processor 104 of FIG. 1, may perform any suitable operations to execute optimizer 225 and operating system 230. The operations described herein as being performed by optimizer 225 or operating system 230 may be performed or executed by processor 220. The components of information handling system 200 may be implemented in hardware, software, firmware, or any combination thereof. The components shown are not drawn to scale and information handling system 200 may include additional or fewer components. In addition, connections between components may be omitted for descriptive clarity.

Battery 205 may be configured to provide power to components of information handling system 200, such as processor 220, embedded controller 210, control framework 250, and processor scheduler 255 when information handling system 200 is not connected to an external power source. A relative state of charge (RSOC) of battery 205 can be the percentage of usable energy of battery 205 stored relative to a full charge capacity of battery 205.

Embedded controller 210 may include a ROM and a random-access memory (RAM), wherein embedded controller 210 may be configured to read an embedded controller firmware, such as embedded optimizer 215. In addition, embedded controller 210 may include a processor to process instructions associated with embedded optimizer 215. Embedded optimizer 215 may be configured to provide an operating system or platform agnostic way to monitor the RSOC of battery 205 on information handling system 200 and dynamically configure the number of different types of processor cores, such as processor cores 240 and 245 that are available for operating system 230. Alternately, embedded optimizer 215 may be configured with a bi-directional API engagement to operating system 230 to adjust the power mode settings of information handling system 200. This allows embedded optimizer 215 to initiate operating system 230 to switch to a more power-efficient processor power management setting.

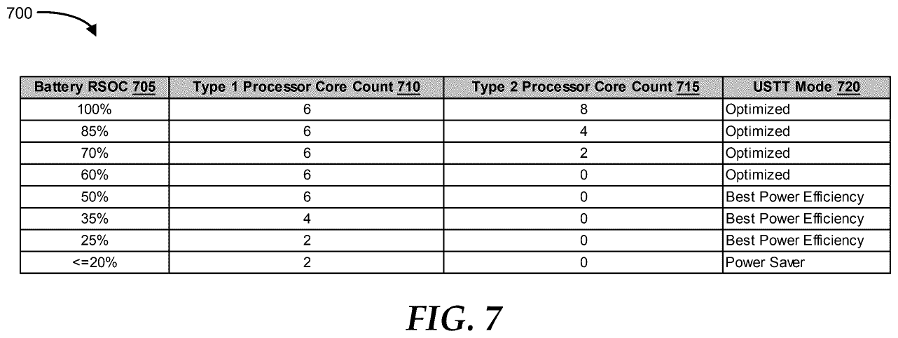

For example, embedded optimizer 215 may be configured to automatically adjust a number of processor and/or processor cores based on a set of criteria that includes the RSOC of battery 205. In particular, embedded optimizer 215 may adjust the number of processor and/or processor cores based on a table 700 of FIG. 7. This may be performed to optimize battery performance which can prolong the battery life. In one embodiment, if information handling system 200 does not include optimizer 225, then embedded optimizer 215 may provide feedback also referred to as a portable code (p-code) hint to control framework 250 to enable or disable a specific processor and/or processor cores.

For example, if battery 205 has a 100% RSOC and a user unplugs an AC adapter from an external power source, embedded optimizer 215 may not change the configuration of the processor and/or processor cores. If after a certain period, embedded optimizer 215 detects that the RSOC of battery 205 drops to 85%, then embedded optimizer 215 may provide the p-code hint to control framework 250 to enable or disable a specific processor and/or processor core(s). Further, when embedded optimizer 215 detects that the RSOC of battery 205 drops to 60%, then embedded optimizer 215 may provide the p-code hint to control framework 250 to turn off one or more of processor cores 240. When embedded optimizer 215 detects a further drop with the RSOC of battery 205, then embedded optimizer 215 may provide the p-code hint to control framework 250 to disable one or more of processor cores 245 until a minimum number of enabled processor cores is reached.

A control framework may direct a processor scheduler to notify the operating system of the processor and/or processor cores that are enabled or disabled. The operating system may then remove the processor and/or processor cores hardware affinity with one or more threads. With the hardware affinity removed, the processor and/or processor cores are unavailable for use. For example, control framework 250 may direct processor scheduler 255 to notify operating system 230 which one of processor cores 240 and 245 are to be enabled or disabled which may be available or unavailable for usage, respectively. Accordingly, operating system 230 may refrain from scheduling threads to the unavailable processor cores.

Embedded optimizer 215 may also be configured to switch a USTT mode from a first mode to a second mode. For example, the USTT mode may be switched from a performance mode or a maximum performance mode to a power saver mode. In another embodiment, embedded optimizer 215 may provide the p-code hint to optimizer 225 to modify the USTT mode according to a pre-defined mapping of a battery's RSOC to a USTT mode. The p-code hint may be based on the RSOC of battery 205 according to table 700 of FIG. 7. For example, if the RSOC of battery 205 is at 100%, then the embedded optimizer may retain the current USTT mode. When the RSOC of battery 205 drops to 50%, then embedded optimizer 215 may provide the p-code hint to optimizer 225 to change the USTT mode to the best power efficiency mode or the quiet mode. In yet another embodiment, if optimizer 225 is not installed in information handling system 200, then embedded optimizer 215 may change the USTT mode by notifying the BIOS and/or control framework 250. For example, the embedded optimizer may change the operating system power mode from a performance mode to a power efficiency mode.

Processor 220 may be a hybrid processor that includes at least two types of processor cores. In this example, processor 220 includes processor cores 240 of a first type and processor cores 245 of a second type. For example, processor cores 240 may be configured for performance while processor cores 245 may be configured for efficiency. In particular, processor cores 240 may be configured with a higher number of instructions per cycle than processor cores 245. Accordingly, processor cores 240 may consume more power than processor cores 245. While the two types of processor cores are shown to be integrated into a single processor die, each type of the processor cores may be incorporated into different processor dies. For example, one processor may include the first type of processor core while a second processor may include the second type of processor core. One of skill in the art will appreciate that processor 220 may have more or fewer processor cores than shown. Also, processor 220 may have more than two types of processor cores. In addition, information handling system 200 may include more than one processor.

Optimizer 225 may be an application configured to manage and/or monitor one or more applications, components, and/or devices in information handling system 200. In particular, optimizer 225 may be configured to automate the optimization of battery runtime based on at least the battery RSOC with embedded optimizer 215. Optimizer 225 may be located remotely from or installed locally at information handling system 200. Optimizer 225 may communicate with embedded optimizer 215 via one or more communication channels, such as a sideband or out-of-band communication channel, a wide area network, a local area network, a wireless local area network, a wireless personal area network, a wireless wide area network, etc.

Control framework 250 may be a centralized framework configured to manage power, thermal, and acoustic characteristics of information handling system 200 based on one or more p-code hints provided by embedded optimizer 215, among others. Processor scheduler 255 may be configured to provide information to operating system 230 regarding which of processor cores 240 and/or 245 is to be enabled or disabled based on the feedback or p-code hints from embedded optimizer 215.

Those of ordinary skill in the art will appreciate that the configuration, hardware, and/or software components of information handling system 200 depicted in FIG. 2 may vary. For example, the illustrative components within information handling system 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

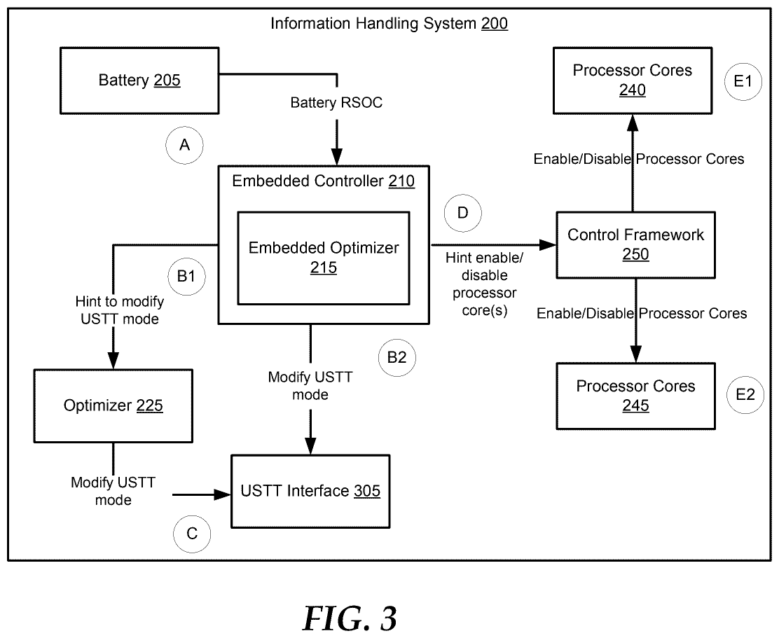

FIG. 3 shows a portion of information handling system 200 of FIG. 2, according to at least one embodiment of the present disclosure. FIG. 3 is annotated with a series of letters A through E1 and E2. Each of these letters represents a stage of one or more operations. Although these stages are ordered for this example, the stages illustrate one example to aid in understanding this disclosure and should not be used to limit the claims. Subject matter falling within the scope of the claims can vary with respect to the order of the operations.

At stage A, embedded optimizer 215 may read or collect battery RSOC from battery 205. Embedded optimizer 215 may process the battery RSOC and transmit a p-code hint to modify the USTT mode to optimizer 225 based on the battery RSOC at stage B1. If optimizer 225 is not installed, embedded optimizer 215 may modify the USTT mode via a USTT interface 305 at stage B2. USTT interface 305 may be used to select a mode from one of different pre-defined USTT modes. Each of the USTT modes is associated with specified fan speed values for individual cooling fans of the system as a function of a sensed battery RSOC. At stage C, optimizer 225 may change the USTT mode via USTT interface 305 based on the p-code hint received from embedded optimizer 215.

At stage D, embedded optimizer 215 may transmit a p-code hint to control framework 250 to enable or disable one or more processors or processor cores. Based on the p-code hint, control framework 250 may perform stage E1, stage E2, or both. At stage E1, control framework 250 may enable or disable one or more of processor cores 240. At stage E2, control framework 250 may enable or disable one or more processor cores 245. The changes to the status of the processor cores, such as whether they were enabled or disabled, may be applied at runtime without a need for a system reboot. Accordingly, an operating system can utilize the enabled processor core to process instructions subsequent to their enablement without a system reboot to apply the changes. Similarly, the operating system cannot utilize the disabled processor cores at this point.

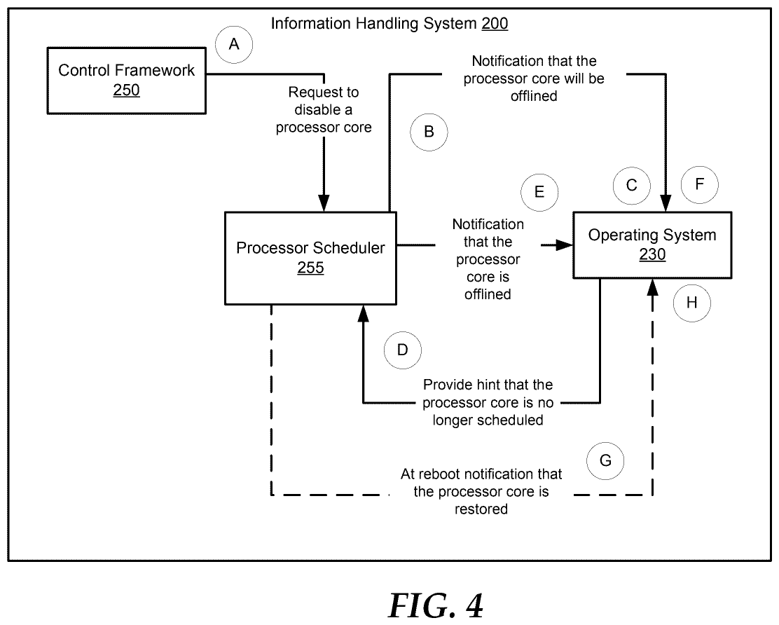

FIG. 4 shows a portion of information handling system 200 of FIG. 2, according to at least one embodiment of the present disclosure. FIG. 4 is annotated with a series of letters A through H. Each of these letters represents a stage of one or more operations. Although these stages are ordered for this example, the stages illustrate one example to aid in understanding this disclosure and should not be used to limit the claims. Subject matter falling within the scope of the claims can vary with respect to the order of the operations.

At stage A, control framework 250 may transmit a request with a p-code hint to disable one or more processor cores to processor scheduler 255. The request may include a specific processor core type to be offlined, such as a performance processor core or an efficient processor core. At stage B, processor scheduler 255 may notify operating system 230 that processor cores in the received request may be offlined. Upon receipt of the notification, operating system 230 may mark a hardware affinity of the processor cores to a task or thread for removal, at stage C.

At stage D, operating system 230 may provide a p-code hint to processor scheduler 255 that the marked processor cores may no longer be scheduled. At stage E, processor scheduler 255 may notify operating system 230 that the marked processor cores may be offline. At stage F, operating system 230 may modify a scheduler processor map to reflect a new set of processors or processor cores for scheduling. The new set of processor or processor cores may not include the marked processor cores. As such, operating system 230 may utilize the new set of processor or processor cores to process instructions without a need to reboot the information handling system. At stage G, at system reboot, processor scheduler 255 may restore the processor cores that were offlined and may notify operating system 230 of a current status of these processor cores. At stage H, operating system 230 may reset the scheduler processor map to its default post system reboot.

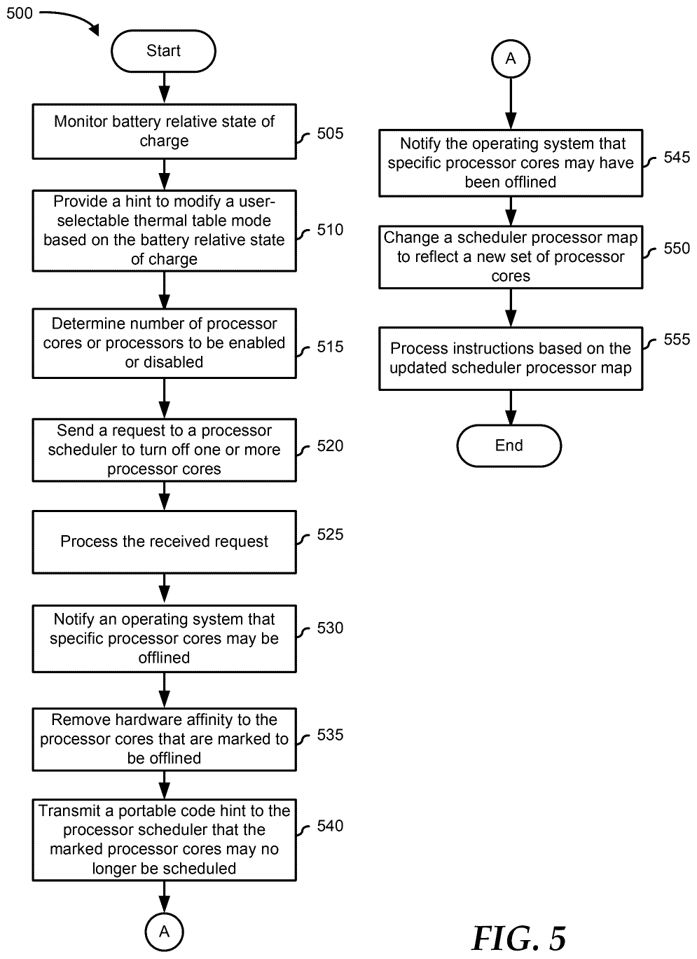

FIG. 5 shows a flowchart of a method 500 for battery runtime optimization. The optimization may be performed dynamically at runtime, such that a configuration change associated with a processor or processor core may be applied and utilized without rebooting the information handling system. Method 500 may be performed by any suitable component of information handling system 200 of FIG. 2 including, but not limited to, embedded optimizer 215 and optimizer 225 of FIG. 2. While embodiments of the present disclosure are described in terms of the components of information handling system 200 of FIG. 2, it should be recognized that other components may be utilized to perform the described method.

Method 500 typically starts at block 505 where an embedded optimizer may monitor the RSOC of an information handling system's battery. The method proceeds to block 510 where the embedded optimizer may modify a current USTT mode based on the battery RSOC according to a pre-defined mapping of the battery RSOC to a USTT mode, such as depicted in table 700 of FIG. 7. The method proceeds to block 515 where the embedded optimizer may determine a number of specific processor core types and/or processor(s) to be enabled or disabled based on a predefined mapping of the battery RSOC to a number of processor cores and/or processors.

The method proceeds to block 520 where a control framework may transmit a request with a p-code to a processor scheduler to turn off a specified set of processor cores or processors. The request may also specify to turn on a specified set of processor cores or processors. In one example, the request may be turned off processor cores 240 of FIG. 2. The method proceeds to block 525 where the processor scheduler may process the request. After processing the request, the processor scheduler may notify an operating system that one or more processor cores may be disabled, parked, or offlined at block 530. The processor scheduler may also notify the operating system that one or more processor cores may be enabled, unparked, or brought online. For example, the processor scheduler may mark the processor core(s) to be, disabled, offlined, or parked. All the processor cores can also be active simultaneously and used by the operating system.

The method proceeds to block 535 where the operating system may remove a hardware affinity of threads to the processor cores that are marked to be offlined, disabled, or parked. The method proceeds to block 540 where the operating system may provide a p-code hint to the processor scheduler that the processor cores with the removed hardware affinity may no longer be part of the schedule. The method proceeds to block 545 where the processor scheduler may transmit a notification of a current status of the marked processor cores to the operating system. For example, the processor schedule may notify the operating system that one or more marked processor cores may have been offlined.

The method proceeds to block 550 where the operating system may change a scheduler processor map to reflect a new set of processors and/or processor cores that can be assigned to tasks or threads. The scheduler processor map may include mapping of processors and/or processor cores to tasks or threads. The method proceeds to block 555 where the operating system may process instructions at runtime based on the updated scheduler processor map, as changes to the scheduler processor map may take place immediately. The updated scheduler processor map may be retained and used by the operating system until a system reboot wherein the updated scheduler processor map may be reset to its default. The method ends.

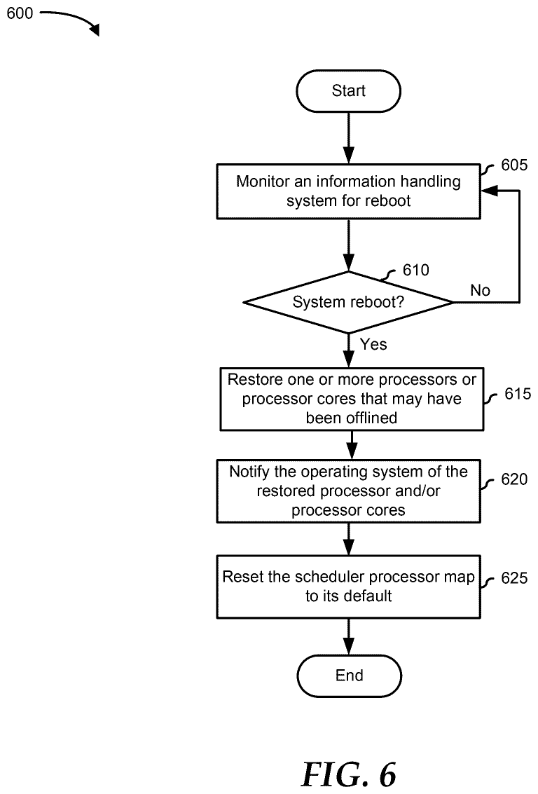

FIG. 6 shows a flowchart of a method 600 for processor core restoration to default status after a system reboot. Method 600 may be performed by any suitable component of information handling system 200 of FIG. 2 including, but not limited to, embedded optimizer 215 and optimizer 225 of FIG. 2. While embodiments of the present disclosure are described in terms of the components of information handling system 200 of FIG. 2, it should be recognized that other components may be utilized to perform the described method.

Method 600 typically starts at block 605 where an optimizer may monitor an information handling system for a system reboot event. The method proceeds to decision block 610 where the processor scheduler may detect a system reboot. If a system reboot is detected, then the “YES” branch is taken, and the method proceeds to block 615. If a system reboot is not detected, then the “NO” branch is taken, and the method proceeds to block 605.

At block 615, during the boot process, the processor scheduler logic may restore the one or more processor and/or processor cores that may have been off-lined and the method proceeds to block 620 where the processor scheduler may notify the operating system of the restored processor and/or processor cores. The method proceeds to block 625 where the operating system may reset the scheduler processor map to its default after a successful boot process. Afterwards, the method ends.

FIG. 7 shows table 700 of a mapping of battery RSOC to processor core counts and USTT modes, according to at least one embodiment of the present disclosure. The mapping may be created by an application or a user, such as a system engineer. The mapping may also be generated and/or updated by the user, optimizer 225, and/or embedded optimizer 215 of FIG. 2. Table 700 is one example and multiple possible examples of USTT tables. Table 700 is described herein as an exemplary table and the USTT table may include different values, such as RSOC percentages, core counts, and USTT mode, without varying from the scope of this disclosure. Table 700 has several columns that include a battery RSOC 705, a type 1 processor core count 710, a type 2 processor core count 715, and a USTT mode 720. Battery RSOC 705 indicates various percentages of the RSOC of battery 205 of FIG. 2. Type 1 processor core count 710 may indicate a count of a first type of processor cores, such as processor cores 240 that is associated with a percentage of the battery RSOC. Type 2 processor core count 715 may indicate a count of a second type of processor cores, such as processor cores 245 that is associated with a percentage of the battery RSOC. For example, if the battery RSOC is 100% then all of the processor cores may be enabled, where in this example there are six cores of processor cores 240 and eight cores of processor cores 245. Similarly, if the battery RSOC is less than or equal to 20% then two of processor cores 240 and none of processor cores 245 may be enabled.

USTT mode 720 indicates a USTT mode that is associated with the battery RSOC. A USTT may include a finite number of different pre-defined user-selectable fan speed modes in the BIOS that are expressed as respective different thermal tables where each one defines a different fan speed policy. Each of these user-selectable modes includes a different set of specified fan speed values for the individual cooling fans of the information handling system as a function of the battery RSOC. In some embodiments, the embedded optimizer may determine an optimal USTT mode. For example, if the battery RSOC is 100%, then the USTT mode may be set to optimized, wherein the fan speed is at its highest setting. Similarly, if the battery RSOC is less than or equal to 20%, then the USTT mode may be set to power saver, wherein the fan speed is at its lowest setting.

The term “user” in this context should be understood to encompass, by way of example and without limitation, a user device, a person utilizing or otherwise associated with the device, or a combination of both. An operation described herein as being performed by a user may therefore be performed by a user device, or by a combination of both the person and the device.

As used herein, a hyphenated form of a reference numeral refers to a specific instance of an element and the un-hyphenated form of the reference numeral refers to the collective or generic element. Thus, for example, processor core “240-1” refers to an instance of a processor core class, which may be referred to collectively as processor cores “240” and any one of which may be referred to generically as a processor core “240.”

Although FIG. 5 shows example blocks of method 500 in some implementations, method 500 may include additional blocks, fewer blocks, different blocks, or differently arranged blocks than those depicted in FIG. 5. Those skilled in the art will understand that the principles presented herein may be implemented in any suitably arranged processing system. Additionally, or alternatively, two or more of the blocks of method 500 may be performed in parallel. For example, blocks 510 and 515 of method 500 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
monitoring, by a processor of an information handling system, a relative state of charge of a battery of the information handling system;
modifying a user-selectable thermal table mode based on the relative state of charge of the battery; and
transmitting, by the processor, a portable code to disable a processor core in a central processing unit of the information handling system based on the relative state of charge of the battery.

2. The method of claim 1, further comprising notifying an operating system of the information handling system to park the processor core.

3. The method of claim 1, further comprising determining a processor core type to be disabled.

4. The method of claim 1, further comprising determining a number of processor cores to be disabled.

5. The method of claim 1, further comprising notifying an operating system that the processor core is offline.

6. The method of claim 1, further comprising in response to detecting a system reboot of the information handling system, enabling the processor core.

7. The method of claim 1, further comprising in response to detecting a system reboot, resetting a scheduler processor map.

8. An information handling system, comprising:
a battery;
a central processing unit including a plurality of processor cores; and
a processor to communicate with the battery, the processor to:
monitor a relative state of charge of the battery;
transmit a first portable code to modify a user-selectable thermal table mode based on the relative state of charge of the battery; and
transmit a second portable code to disable one of the processor cores of the central processing unit based on the relative state of charge of the battery.

9. The information handling system of claim 8, wherein the processor is configured to notify an operating system of the information handling system to park the one of the processor cores.

10. The information handling system of claim 8, wherein the processor is further configured to determine a processor core type to be disabled.

11. The information handling system of claim 8, wherein the processor is further configured to determine a number of the processor cores to be disabled.

12. The information handling system of claim 8, wherein the processor is further configured to notify an operating system that the one of the processor cores is offline.

13. The information handling system of claim 8, wherein the processor is further configured to enable the one of the processor cores in response to a detection of a system reboot of the information handling system.

14. The information handling system of claim 8, wherein the processor is further configured to reset a scheduler processor map in response to a detection of a system reboot.

15. A non-transitory computer-readable medium to store instructions that are executable to perform operations comprising:
monitoring a relative state of charge of a battery of an information handling system;
modifying a user-selectable thermal table mode based on the relative state of charge of the battery; and
transmitting a portable code to disable a processor core of the information handling system based on the relative state of charge of the battery.

16. The non-transitory computer-readable medium of claim 15, wherein the operations further comprise notifying an operating system of the information handling system to park the processor core.

17. The non-transitory computer-readable medium of claim 15, wherein the operations further comprise determining a processor core type to be disabled.

18. The non-transitory computer-readable medium of claim 15, wherein the operations further comprise notifying an operating system that the processor core is offline.

19. The non-transitory computer-readable medium of claim 15, wherein the operations further comprise in response to detecting a system reboot of the information handling system, enabling the processor core.

20. The non-transitory computer-readable medium of claim 15, wherein the operations further comprise in response to detecting a system reboot, resetting a scheduler processor map.
